(19) United States
(12) Patent Application Publication
(10) Pub. No.: US 2023/0316562 A1
(43) Pub. Date: Oct. 5, 2023

(54) CAUSAL INTERACTION DETECTION APPARATUS, CONTROL METHOD, AND COMPUTER-READABLE STORAGE MEDIUM

(71) Applicant: NEC Corporation, Minato-ku, Tokyo (JP)

(72) Inventor: Karen Stephen, Tokyo (JP)

(73) Assignee: NEC Corporation, Minato-ku, Tokyo (JP)

(21) Appl. No.: 18/019,879

(22) PCT Filed: Aug. 19, 2020
(86) PCT No.: PCT/JP2020/031233

§ 371 Date: Feb. 6, 2023

(51) Int. Cl. G06T 7/73; G06T 7/246; G06V 10/74

(52) U.S. Cl. CPC G06T 7/73; G06T 7/246; G06V 10/761; G06T 2207/30196

(57) ABSTRACT

A causal interaction detection apparatus (2000) extracts pose information for each of persons detected from a video data. The pose information indicates poses of the person in time series. The causal interaction detection apparatus (2000) generates, for each of the persons, a change model that shows change in pose over time based on the pose information. The causal interaction detection apparatus (2000) determines, for each of one or more sets of a plurality of the persons, whether times of changes in pose of the persons in the set correlate with each other. The causal interaction detection apparatus (2000) detects the persons whose times of changes in pose are determined to correlate with each other, as the persons having a causal relationship with each other.

### TECHNICAL FIELD

The present disclosure generally relates to a technique to detect causal interactions between multiple persons from videos.

### BACKGROUND ART

Causal person-person interaction refers to those interactions involving two or more people where there is a cause and effect relationship in the interactions of the people involved. Various interactions between people, where one person’s action or state is affected by another person’s action or state, make them causal interactions.

NPL 1 and NPL 2 are examples that disclose techniques to detect causal person-person interaction from video data. NPL 1 discloses a system for detecting causal person-person interactions based on the concept of Granger Causality. According to the definition of Granger Causality, a time series data {x(t)} is considered to Granger-cause another time series data {y(t)}, if knowing the past values of x(t) leads to a better prediction of y(t). The system of NPL1 uses a trajectory of head-keypoints of the people in a scene in the video data as the time series data. According to NPL 1, the trajectory of a head-keypoint of a person in the scene is represented as a linear combination of the head-keypoints of the other people in the scene and the problem of finding causal interactions as a sparse graph identification problem is considered.

NPL 2 discloses a system that uses person skeletal keypoints to recognize two-person interactions. In NPL 2, an SVM (Support Vector Machine) is trained in advance so that it feeds a video data containing a two-person interaction and classifies their interaction into one of the predefined interaction classes.

### CITATION LIST

### Non Patent Literature

NPL 1: Mustafa Ayazoglu, Burak Yilmaz, Mario Sznaier, and Octavia Camps, “Finding Causal Interactions in Video Sequences”, 2013 IEEE International Conference on Computer Vision, Dec. 1, 2013.
NPL 2: Kiwon Yun, Jean Honorio, Debaleena Chattopadhyay, Tamara L. Berg, and Dimitris Samaras, “Two-person interaction detection using body-pose features and multiple instance learning”, 2012 IEEE Computer Society Conference on Computer Vision and Pattern Recognition Workshops, Jun. 16, 2012.

### SUMMARY OF INVENTION

### Technical Problem

The above-mentioned systems fail to detect various types of person-person interactions. Specifically, the system described in NPL 1 fails to detect person-person interactions in which the person skeletal poses vary significantly, without much change in the head keypoint trajectory. The reason for the occurrence of this problem is that NPL 1 uses the trajectory information of only a single keypoint of the people in a scene in video data. Note that the method described in NPL 1 cannot be directly extended to multiple keypoints because the trajectory of keypoints of a single person cannot be expressed as a linear combination of keypoints of other people (the relationship is not linear).

In terms of NPL2, the person-person interactions that can be detected by the system described in it are limited to predetermined ones since the SVM in the system has to be trained in advance with training data that shows one of known types of interactions. Thus, it is difficult for this system to detect unknown types of person-person interactions.

One of objectives of the present disclosure is to provide a technique to detect various types of causal interactions between people.

### Solution to Problem

The present disclosure provides a causal interaction detection apparatus that comprises: at least one processor; and memory storing instructions. The at least one processor is configured to execute the instructions to: extract pose information for each of persons detected from a video data, the pose information indicating poses of the person in time series; generate, for each of the persons, a change model that shows change in pose over time based on the pose information; determine, for each of one or more sets of a plurality of the persons, whether times of changes in pose of the persons in the set correlate with each other; and detect the persons whose times of changes in pose are determined to correlate with each other, as the persons having a causal relationship with each other.

The present disclosure further provides a control method that is performed by a computer. The control method comprises: extracting pose information for each of persons detected from a video data, the pose information indicating poses of the person in time series; generating, for each of the persons, a change model that shows change in pose over time based on the pose information; determining, for each of one or more sets of a plurality of the persons, whether times of changes in pose of the persons in the set correlate with each other; and detecting the persons whose times of changes in pose are determined to correlate with each other, as the persons having a causal relationship with each other.

The present disclosure further provides a non-transitory computer readable storage medium storing a program. The program that causes a computer to execute the control method of the present disclosure.

### Advantageous Effects of Invention

According to the present disclosure, it is possible to provide a technique to detect various types of causal interactions between people.

### BRIEF DESCRIPTION OF DRAWINGS

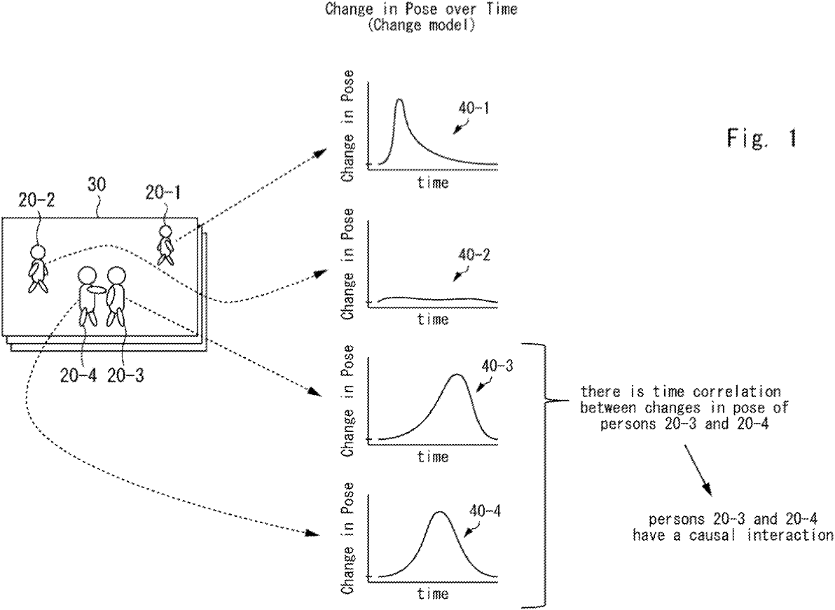

### [FIG. 1]

FIG. 1 illustrates an overview of a causal interaction detection apparatus according to the 1st example embodiment.

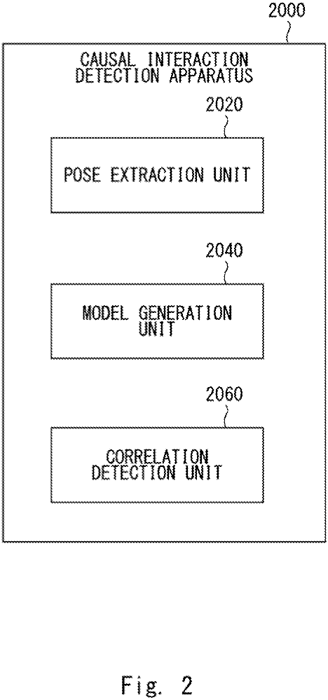

### [FIG. 2]

FIG. 2 is a block diagram illustrating an example of the functional configuration of the causal interaction detection apparatus of the 1st example embodiment.

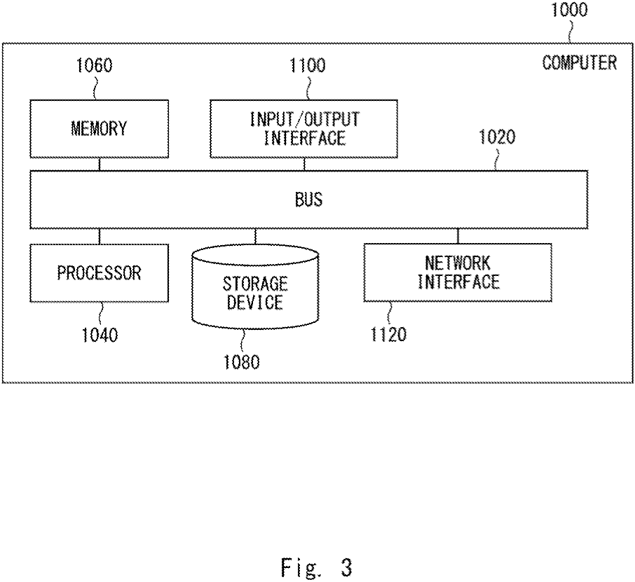

### [FIG. 3]

FIG. 3 is a block diagram illustrating an example of the hardware configuration of a computer realizing the causal interaction detection apparatus.

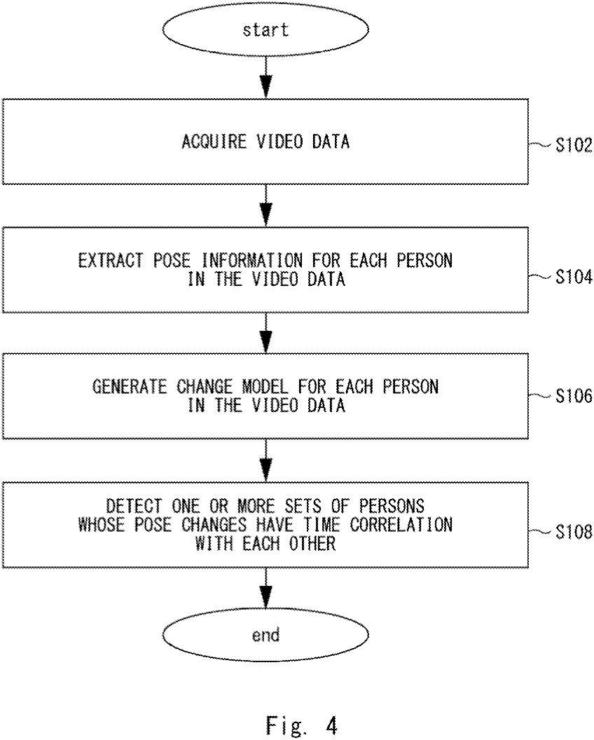

### [FIG. 4]

FIG. 4 is a flowchart illustrating an example flow of processes that the causal interaction detection apparatus of the 1st example embodiment performs.

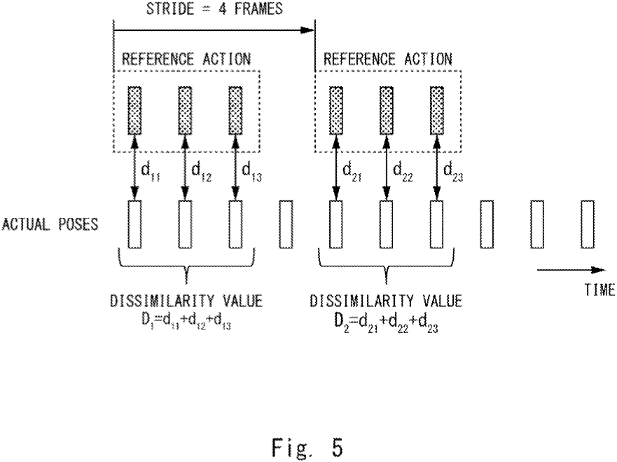

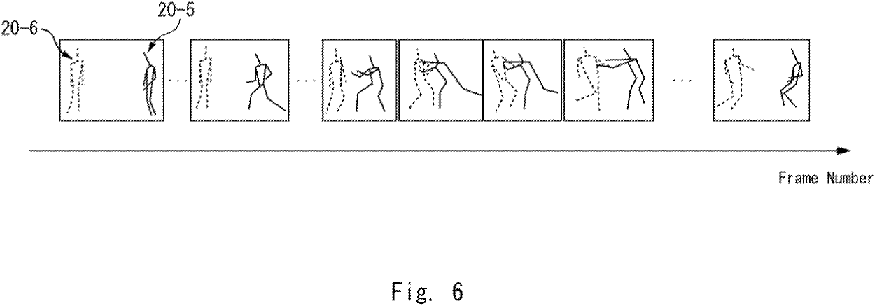

### [FIG. 5]

FIG. 5 illustrates an example way of computing the dissimilarity between a set of actual poses of the person and the reference action.

### [FIG. 6]

FIG. 6 illustrates a case where two persons interacting with each other.

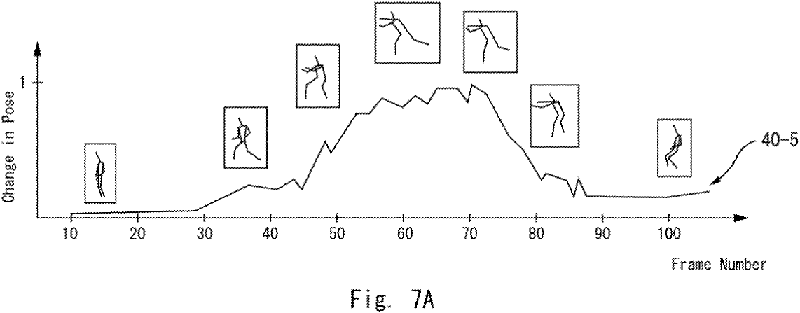

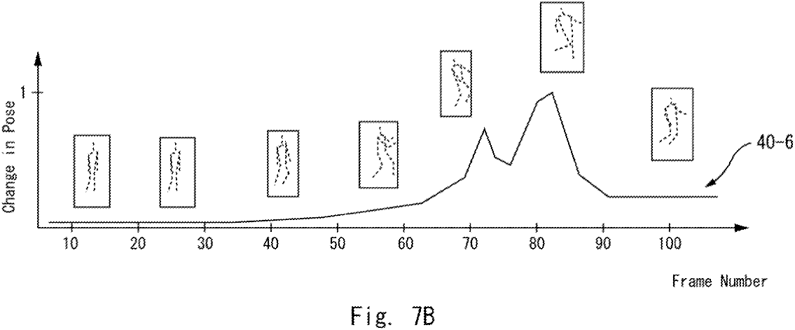

### [FIG. 7A]

FIG. 7A illustrates the change model for the person.

### [FIG. 7B]

FIG. 7B illustrates the change model for the person.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary.

### First Example Embodiment

### <Overview>

FIG. 1 illustrates an overview of a causal interaction detection apparatus according to the 1st example embodiment. Please note that FIG. 1 does not limit operations of the causal interaction detection apparatus, but merely shows an example of possible operations of the causal interaction detection apparatus.

The causal interaction detection apparatus is used to detect a causal interaction between multiple persons 20 captured in a video data 30. In order to detect the causal interaction between the persons 20, the causal interaction detection apparatus analyzes the video 30 and generates a model of changes in pose over time (hereinafter, change model) for each person 20. Then, the causal interaction detection apparatus 20 compares change models of the persons 20 with each other, thereby identifying the correlation between the times at which significant pose-changes occur for multiple persons 20 in the video data 30. Then, the causal interaction detection apparatus 20 generates one or more sets (hereinafter, detection set) of the persons 20, each detection set indicating the persons 20 between whom there is a causal interaction. Specifically, the persons 20 whose times of changes in pose correlate with each other are included in the same detection set as each other. For example, the causal interaction detection apparatus detects that there is a causal interaction between the persons 20 when the times of their pose changes overlaps with each other.

For example, in FIG. 1, four persons 20-1 to 20-4 are detected from the video data 30. The change models 40-1 to 40-4 describe changes in pose over time for the persons 20-1 to 20-4, respectively. By comparing the change model 40-1 with the other change models 40-2 to 40-4, it can be found that there is no other person 20 whose times of significant pose changes correlate with that of the person 20-1. The same applies to the person 20-2.

On the other hand, by comparing the change models 40-3 and 40-4, it is found that the person 20-3 makes significant pose changes during a time period that overlaps the time period during which the person 20-4 makes significant pose changes. Thus, the causal interaction detection apparatus determines that there is a causal interaction between the persons 20-3 and 20-4.

### <Example of Advantageous Effect>

According to the causal interaction detection apparatus of the 1st example embodiment, the change model 40 that describes changes in pose over time is generated for each person 20 detected from the video data 30. Based on the change models 40 generated, the causal interaction detection apparatus detects the persons 20 whose changes in pose have a time correlation with each other, and such persons 20 are considered to have a causal interaction.

With this method, it is not required to prepare a learned model that is trained to detect a predefined type of person-person interaction. Thus, causal interactions that the causal interaction detection apparatus can detect are not limited to predetermined types of interactions. In addition, as described later in detail, it is inherently possible for the causal interaction detection apparatus to handle poses described by multiple keypoints. Thus, causal interactions that the causal interaction detection apparatus can detect are not limited to those in which poses are described by a single keypoint. Thus, the causal interaction detection apparatus can detect various types of causal interactions.

Hereinafter, more detailed explanation of the causal interaction detection apparatus will be described.

### <Example of Functional Configuration>

FIG. 2 is a block diagram illustrating an example of the functional configuration of the causal interaction detection apparatus 2000 of the 1st example embodiment. The causal interaction detection apparatus 2000 includes a pose extraction unit 2020, model generation unit 2040, and correlation detection unit 2060. The pose extraction unit 2020 extracts pose information for each of the persons 20 from the video data 30. The pose information of the person 20 indicates poses of the person 20 in time series. The model generation unit 2040 generates the change model 40 for each of the persons 20. The correlation detection unit 2060 detects one or more sets of a plurality of the persons 20 whose times of changes in pose correlate with each other based on the change models 40.

### <Example of Hardware Configuration of Causal Interaction Detection apparatus 2000>

The causal interaction detection apparatus 2000 may be realized by one or more computers. Each of the one or more computers may be a special-purpose computer manufactured for implementing the causal interaction detection apparatus 2000, or may be a general-purpose computer like a personal computer (PC), a server machine, or a mobile device. The causal interaction detection apparatus 2000 may be realized by installing an application in the computer. The application is implemented with a program that causes the computer to function as the causal interaction detection apparatus 2000. In other words, the program is an implementation of the functional units of the causal interaction detection apparatus 2000.

FIG. 3 is a block diagram illustrating an example of the hardware configuration of a computer 1000 realizing the causal interaction detection apparatus 2000. In FIG. 3, the computer 1000 includes a bus 1020, a processor 1040, a memory 1060, a storage device 1080, an input/output interface 1100, and a network interface 1120.

The bus 1020 is a data transmission channel in order for the processor 1040, the memory 1060, the storage device 1080, and the input/output interface 1100, and the network interface 1120 to mutually transmit and receive data. The processor 1040 is a processer, such as a CPU (Central Processing Unit), GPU (Graphics Processing Unit), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The input/output interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The storage device 1080 may store the program mentioned above. The CPU 1040 executes the program to realize each functional unit of the causal interaction detection apparatus 2000.

The hardware configuration of the computer 1000 is not limited to the configuration shown in FIG. 3. For example, as mentioned-above, the causal interaction detection apparatus 2000 may be realized by plural computers. In this case, those computers may be connected with each other through the network.

### <Flow of Process>

FIG. 4 is a flowchart illustrating an example flow of processes that the causal interaction detection apparatus 2000 of the 1st example embodiment performs. The pose extraction unit 2020 acquires the video data 30 (S102). The pose extraction unit 2020 extracts the pose information for each person 20 from the video data 30 (S104). The model generation unit 2040 generates the change model 40 for each person 20 based on the extracted pose information of the person 20 (S106). The correlation detection unit 2060 detects one or more sets of the persons 20 whose times of changes in pose correlate with each other (S108).

### <Acquisition of Video Data 30: S102>

The pose extraction unit 2020 acquires the video data 30 (S102). There are various ways to acquire the video data 30. For example, the pose extraction unit 2020 acquires the video data 30 from a camera that generates the video data 30. In another example, the pose extraction unit 2020 acquires the video data 30 from a storage device into which the camera has written the video data 30.

A camera generating the video data 30 may be an arbitrary camera that can capture multiple persons 20. For example, the camera may be a surveillance camera installed at a place to be surveilled. In another example, the camera may be a mobile camera that is attached to a person or an object, e.g. a drone, that patrols a designated place.

The video data generated by the camera may be divided into multiple video data 30. For example, each of every predetermined length (e.g. 1 minute) of video data generated by the camera is handled as the video data 30. Note that the video data may be divided into multiple video data 30 so that respective parts of two adjacent video data 30 overlap each other.

### <Extraction of Pose Information: S104>

The pose extraction unit 2020 extracts pose information for each person 20 from the video data 30 (S104). The pose information of a person 20 shows poses of that person 20 in time series (in other words, a sequence of poses of the person 20 over time). For example, the pose information describes a pose of the person 20 for each time frame of the video data 30. In this case, the pose extraction unit 2020 computes the pose of the person 20 for each time frame of the video 30, and generates the pose information that shows a sequence of the computed poses of the person 20. Note that the pose information is not necessarily required to show the pose of the person 20 for each frame. For example, the pose information indicates the poses of the persons 20 for every several frames.

In order to compute poses of each person 20, the pose extraction unit 2020 detects persons 20 from frames of the video data 30. For example, the detected person 20 is represented by co-ordinates of its bounding box in the frame. Then, the pose extraction unit 2020 tracks these detected human bounding boxes across the frames of the video data 30. By doing so, the bounding boxes that represent the persons 20 the same as each other are identified across the frames. The pose extraction unit 2020 extracts the skeletal keypoints co-ordinates for each of the detected and tracked persons 20. As a result, the pose extraction unit 2020 generates the pose information that includes a time sequence of the skeletal keypoints co-ordinates of the person 20, for each person 20 detected from the video data 30.

Note that the order of operation can be different. For example, instead of tracking the person bounding boxes and then extracting the skeletal keypoint co-ordinates, skeletal keypoint co-ordinates can be extracted first from the video data 30 and then tracked across the frames of the video data 30.

### <Generation of Change Model: S106>

The model generation unit 2040 generates the change model 40 for each person 20 in the video data 30 based on the extracted pose information of the person 20 (S106). Specifically, for each of the persons 20 detected from the video data 30, the model generation unit 2040 models the change in pose of the person 20 as a function of time.

The change in pose at time t may be modeled by comparing a pose Pt at the time t with a reference pose Pref, and computing a dissimilarity value for Pt that represents how different the pose Pt is from the reference pose Pref. This enables to track how the pose of the person 20 is changing with respect to time.

### <<Details of Reference Pose>>

The reference pose Pt represents a pose of the person 20 that is considered to be normal in a scene (in the whole or a part of the video 30). There are various ways to define the reference pose depending on the scenario. For example, the reference pose of the person 20 is defined by her/his pose in one of the initial frames in which she/he appears in the video data 30, e.g. the pose of any one of the first to fifth frames where she/he appears. In this way, the reference pose is defined for each of the person 20 separately. Note that it is possible that the first few frames do not include all of the skeletal keypoints of that person 20. For example, if the person 20 is at the edge of the frame, only some of her/his keypoints would be visible. Thus, choosing any one of fixed initial frames may be better, e.g. 5th frame or 10th frame.

Another way to define the reference pose is from the knowledge about the scene captured in the video 30 and what is the most common pose in that scene, where certain actions are happening. Suppose that the video data 30 is generated by a surveillance camera installed in a place where most of the people are walking on a pedestrian side-walk. In this case, the most common pose in the scene may be ‘standing upright’. Thus, a pose depicting standing upright can be used as the reference pose. In another example, suppose that the scene is of a cycling lane where most of the people are cycling. In this case, a pose depicting “pedaling a bicycle”, where the back of a person is bent and her/his hands are holding on to the bicycle handles, may be a suitable reference pose. In these cases, the reference pose is stored in a storage device to which the causal interaction detection apparatus 2000 has access in advance.

The reference pose may not necessarily be defined based on a single frame, but a sequence of frames. In other words, the reference pose can be defined by a series of poses, e.g. an action. In this case, the reference pose may also be called “a reference action”. The examples explained above when extended to include multiple frames would correspond to the action of walking or cycling. Specifically, for the video frame 30 in which walking is a common action, the reference pose may be defined by a sequence of poses depicting an action of walking, e.g. the motion of hands and legs in walking. On the other hand, for the video frame 30 in which cycling is a common action, the reference pose may be defined by a sequence of poses depicting an action of cycling, e.g. the motion of legs in cycling.

In the case where the reference action is used, the dissimilarity between poses of the person 20 and the reference action is calculated by considering set of poses of the person 20 in a sliding window fashion. FIG. 5 illustrates an example way of computing the dissimilarity between a set of actual poses of the person 20 and the reference action. In this example, the reference action is defined by a sequence of three reference poses. Thus, a size of a sliding window is three. In addition, a stride of sliding window is four.

First, the model generation unit 2040 compares the reference action with the first set of actual poses of the person 20 that includes the first to third actual poses of the person 20, thereby computing the dissimilarity value therebetween. Specifically, the distance d11 between the first actual pose and the first reference pose, the distance d12 between the second actual pose and the second reference pose, and the distance d13 between the third actual pose and the third reference pose are computed, respectively. Based on those computed distances, the dissimilarity value D1 between the first set of actual poses and the reference action is calculated. In this example, the dissimilarity value is computed as a sum of distances between the actual poses and the reference poses: the dissimilarity value D1=d11+d12+13.

Next, the model generation unit 2040 compares the reference action with the second set of actual poses of the person 20 in the same manner. Since the stride is four in this example, the second set of actual poses includes the fifth to seventh actual poses.

Reference poses may be fixed for all frames, or may be updated as a function of time. In the latter case, if the pose of the person 20 changes to a new pose and this new pose continues for a long time, the reference pose can be updated to be this new pose. For example, consider a person who is walking and later sits down and continues in that state of sitting down for a long time before doing some other action. In this case, the initial reference pose will be the pose corresponding to ‘standing’ and then the reference pose can be updated to the pose corresponding to ‘sitting’, because that is her/his new normal state. Updating the reference pose can be done by finding how long the person 20 has been in the current state. Specifically, for example, the reference pose is updated to a new pose if a pose of the person 20 changes to a new one that is different from the current reference pose, and the person 20 keeps in the new pose for a predetermined length of time or more.

### <<Details of Dissimilarity Value>>

The dissimilarity value for the pose of the person 20 may be computed, for example, as a distance between that pose and the reference pose. There are various ways to describe the distance between two poses, such as a cosine distance or a weighted distance. When using weight distance, each keypoint of the person 20 is assigned a custom weight.

It is also possible to use a learning-based way to calculate the dissimilarity value between a target pose (a pose for which the dissimilarity value is computed) and the reference pose. Specifically, the model generation unit 2040 includes a learned regression model that feeds a pair of a target pose and the reference pose, and outputs the dissimilarity value there between. This regression model is trained in advance with multiple training data each of which associates a pair of a target pose and a reference pose with the dissimilarity value for that pair (in other words, the dissimilarity value to be output from the regression model that has fed that pair).

### <Detection of Causal Interaction: S108>

The correlation detection unit 2060 detects one or more sets of the persons 20 whose times of changes in pose correlate with each other (S108). This means that the correlation detection unit 2060 finds the relationship between the time instants of the people who have a significant change in their respective poses. If there is a correlation between the time indices at which multiple people’s poses change significantly, then those people are highly likely to be interacting. Note that a “significant pose change” may be defined as a change in pose whose dissimilarity value is equal to or greater than a predetermined threshold.

For example, the correlation detection unit 2060 chooses each arbitrary set of the persons 20 in turn, and determines whether the times of changes in pose of the persons 20 in the chosen set have a predetermined time correlation by comparing their change models 40. If it is determined that they have the predetermined time correlation, the correlation detection unit 2060 handles the chosen set as a detection set; this means that it has been determined that there is a causal interaction between the persons 20 in the chosen set. If it is determined that they do not have the predetermined time correlation, the correlation detection unit 2060 does not handle the chosen set as a detection set; this means that it has been determined that there is no causal interaction between the persons 20 in the chosen set.

There may be various predetermined time correlations between the pose changes of the persons 20 who are considered to have a causal interaction. One example of such a correlation is an overlap of significant pose changes in time. Suppose that the pose of a person 20 significantly changes in a certain time window. Suppose also that this time window overlaps with another one in which the pose of another person 20 significantly changes. In this case, the times of changes in pose of those persons 20 are considered to be correlated, and there is high possibility that those two persons 20 have a causal interaction.

Thus, the correlation detection unit 2060 determines whether the time windows of the significant pose changes of the persons 20 in the chosen set overlap each other for a predetermined length of time or longer by comparing their change models 40. If those time windows are determined to overlap each other for the predetermined length or longer, the correlation detection unit 2060 handles the chosen set as a detection set.

Examples of interactions whose time windows overlap each other are shaking hands and hugging. For these actions, the time windows of changes in pose of the persons 20 involved overlap largely because these actions are performed almost simultaneously by them, and therefore their poses would change almost simultaneously. For actions such as pushing, punching, kicking, and so on, there would still be overlapping, but the extent of overlap would be less since the actions of a person appears after the actions of the other person (i.e., the pose change of an effect start only after the pose change of a cause has already started).

As explained above, the length of overlap between the time windows may depend on actions of the persons 20. Thus, the threshold for detecting the overlap between the time windows may be defined in advance based on what kind of causal interaction the causal interaction detection apparatus 2000 is required to detect.

Multiple persons 20 could have a causal interaction even in a case where their time windows of significant pose change do not overlap each other. For example, an action of a cause could finish at the same time or a short time before an action of an effect starts. In other words, there may be a certain amount of interval between the action of the cause and the action of the effect. Thus, a correlation that “an interval between the time windows of the significant pose changes of the persons 20 in the chosen set is equal to or less than a predetermined threshold” may be used as another predetermined time correlation. In this case, for the persons 20 in the chosen set, the correlation detection unit 2060 detects the time windows in which there are significant pose changes, and computes an interval between the time windows. If the computed interval is equal to or less than the predetermined threshold, the correlation detection unit 2060 handles the chosen set as a detection set.

### <<Other Factors for Detecting Correlation>>

The correlation detection unit 2060 may use other factors than a time correlation of pose changes in order to improve the accuracy of detecting a causal interaction between persons 20. One of such factors may be distance between persons 20. Even if there is a time correlation between significant pose changes of the persons 20, there may be no causal interaction between them if they are far from each other. Thus, the correlation detection unit 2060 may take the distance between persons 20 into consideration.

For example, the correlation detection unit 2060 performs the determination of whether there is a causal interaction between the persons 20 in the chosen set, only when the distance between those persons 20 is equal to or less than a predetermined threshold. In other words, the correlation detection unit 2060 determines that there is no causal interaction between the persons 20 in the chosen set if their distance is larger than the predetermined threshold, regardless of the time correlation of their changes in pose.

The determination regarding the distance between the persons 20 in the chosen set may be performed after the determination regarding the time correlation of pose changes of the persons 20. In this case, the correlation detection unit 2060 determines, for each detected set, whether or not the distance between the persons 20 in the detected set is equal to or less than the predetermined threshold. Then, the correlation detection unit 2060 determines that the persons 20 in the detected set has a causal interaction when the distance between them is equal to or less than the predetermined threshold.

The determination regarding the distance between the persons 20 in the chosen set may be performed by a learned model. For example, the learned model is trained on pair of person images to identify if they are interacting based on the distance therebetween.

A direction in which the person 20 is facing may be used as another factor to improve the accuracy of detecting whether or not there is a causal interaction between the persons 20. Specifically, it is highly possible that a person 20 faces to another person 20 if there is a causal interaction between them. On the other hand, there may be no causal interaction between the persons 20 if they face in opposite directions, even if their changes in pose have a time correlation. Thus, it is possible to improve the accuracy of detecting the causal interaction between the persons 20 by taking their directions in which they are facing into consideration.

For example, the correlation detection unit 2060 determines whether there is a time correlation between changes in pose of the persons 20 in the chosen set, only when target parts of the persons 20 face each other. The target part may be, for example, a head, body, or eyes of the person 20. Specifically, when the target parts of the persons 20 face each other, the difference between the directions in which the target parts are facing may be equal or close to 180 degrees. Thus, for example, the correlation detection unit 2060 computes the difference D between the directions in which the target parts of the persons 20 are facing, and determines whether D satisfies “180-m<=D<=180+m”, where m is a predetermined margin. Note that the parameter m is a real number, greater than 0 and less than 180 (for example, m=45).

If the difference D satisfies the above condition, the correlation detection unit 2060 determines that the persons 20 face each other, and then compares the change models 40 of them in order to determine whether or not there is a predetermined time correlation between their changes in pose. On the other hand, if the difference D does not satisfy the above condition, the correlation detection unit 2060 determines that the persons 20 do not face each other. Thus, their change models 40 are not compared with each other. Note that it is possible to apply a well-known technique to compute a direction in which a part of a person, such as head, body, or eyes, is facing in video data.

There may be a case where the persons 20 interact with each other while not facing each other. For example, the persons 20 interacting with each other may face a common target. Thus, the correlation detection unit 2060 may use a condition “the persons 20 face a common target” instead of “the persons 20 face each other”.

Similar to the determination regarding the distance between the persons 20 in the chosen set, the determination regarding the direction in which the persons 20 in the chosen set are facing may be performed after the determination as to whether or not there is a time correlation between pose changes of the persons 20. In addition, the determination regarding the direction in which the persons 20 in the chosen set are facing may be performed by a learned model. For example, the learned model is trained on a pair of person images to identify if they are interacting based on directions in which they are facing.

Using additional factors to determine whether or not there is a causal interaction between people mentioned above is particularly useful in cases when there are multiple groups of people, who are causally interacting within each of their groups. Considering the features like distance and directions helps to differentiate these people into multiple groups rather than mis-detecting them as if all of them interact with each other and belong to a single group.

### <Output Based on Detection Result>

The causal interaction detection apparatus 2000 may generate output information based on the detected set of the persons 20, and outputs the output information. There may be various types of information to be output. For example, the output information indicates one or more sets of the persons 20 that are determined to have a causal interaction. In the output information, the person 20 may be represented by the co-ordinates of her/his person bounding box in the corresponding frame in the video data 30. In another example, the person 20 may be represented by a partial image of the corresponding frame, e.g. an image area of her/his person bounding box in the frame. In another example, the output information may represent each of the persons 20 by including the video data 30 each of whose frames is modified to show the person bounding boxes of the persons 20 to be represented by the output information.

The output information may further include the type of social groups to which the persons 20 in the detected set belong (such as family, friends, colleagues, etc.) by using additional features like age, gender, clothing and the objects carried by the persons 20. For this purpose, a learned model can be used that takes the images of the persons 20 in the detected set as well as the scene information as input and extracts useful features from it to classify those persons 20 into one of the social groups.

The output information mentioned above may be output in various manners. For example, the causal interaction detection apparatus 2000 outputs the output information to a display device, thereby displaying the output information on the display device. The display device may be, for example, observed by security guards in a security room. In another example, the causal interaction detection apparatus 2000 sends the output information to another computer, such as a mobile device that is used by a security guard in the scene or a security room, or by an operator of the causal interaction detection apparatus 2000. In another example, the causal interaction detection apparatus 2000 puts the output information into a storage device for later use.

### EXAMPLE

Hereinafter, an example operation of the causal interaction detection apparatus 2000 will be described. Note that the operation of the causal interaction detection apparatus 2000 described below is an example of various possible operations of the causal interaction detection apparatus 2000, and operations of the causal interaction detection apparatus 2000 are not limited to the following example.

FIG. 6 illustrates a case where two persons 20 are interacting with each other. The interaction considered here is ‘pushing’, where the person 20-5 is pushing the person 20-6. Note that the following explanations hold for any interactions.

FIG. 6 shows several frames of video data 30 input to the causal interaction detection apparatus where the interaction is present. Note that the video data 30 in FIG. 6 is cropped and centered around the two persons 20-5 and 20-6 for ease of illustration. Initially the person 20-5 and 20-6 are standing stationary. Then, the person 20-5 starts moving towards the person 20-6, and pushes him. This push causes the person 20-6 to move backward.

In FIG. 6, the persons 20-5 and 20-6 are depicted by their skeletal pose co-ordinates. Here, 15 skeletal keypoints are considered, namely: head, nose, neck, right shoulder, right elbow, right wrist, left shoulder, left elbow, left wrist, right hip, left hip, right knee, right ankle, left knee and left ankle. Each keypoint is associated with an (x,y) co-ordinate representing the pixel location of the keypoint in the image frame. Note that, instead of 2D skeletal keypoints of the person shown in FIGS. 6, 3D skeletal keypoints of the person can be used as well.

The person can be present at any location in the image and could have different scales across frames based on the distance of the person from the camera. Therefore, to compare different poses correctly, it is preferable to normalize the skeletal pose by translating and scaling to a fixed size. This gives the normalized time-series pose for each person 20.

Next, for finding how the pose of each person is changing with time, firstly a reference pose Pref is selected for each person 20. In this example, the pose of the person 20 in the first frame (standing upright) is chosen as the reference pose Pref for the person 20. In addition, in this example, the dissimilarity value between the pose of the person 20 at a frame and the reference pose (i.e. degree of change in pose) is computed for each frame as a cosine distance between a pose vector of the person 20 at the frame and the pose vector of the reference pose. Note that the pose vector of a person at a frame is a matrix that includes co-ordinates of skeletal keypoints of the person at the frame. The cosine distance mentioned above may be computed using the following equation:

$$D \left({p}_{k} , {p}_{r e f}\right) = 1 - \frac{{p}_{k} {}^{T} {p}_{r e f}}{\left‖{p}_{k}\right‖ \left‖{p}_{r e f}\right‖} \qquad \text{Equation 1:}$$

Note that, in the above equation (1), p_k represents the pose vector of the person 20 at the k-th frame, p_ref represents the pose vector of the reference pose P_ref, and D(p_k, p_ref) represents the cosine distance therebetween.

The equation (1) gives a set of the dissimilarity values for each person 20 as a function of the frame number, i.e. D(p_1, p_ref), D(p_2, p_ref), ..., and D(p_N, p_ref) where N represents the total number of frames in the video data 30. This set of the dissimilarity values represents how the pose of each frame is different as compared to the reference pose. Thus, this set of the dissimilarity values can be used as the change model 40.

FIGS. 7A and 7B show the change model 40 for the persons 20-5 and 20-6, respectively. From FIG. 7A, it can be seen that the pose of the person 20-5 does not change much compared to her/his reference pose, in the beginning and the ending frames, but changes significantly between frame number 50 and frame number 80 as the person 20-5 pushes 20-6. Similarly, from FIG. 7B, it can be seen that the pose of the person 20-6 changes sharply and significantly for frame numbers between 70 and 90 as the person 20-6 is being pushed by the person 20-5.

Next, the time correlation between the change models 40 in FIGS. 6A and 6B is computed by considering the time instants at which there is a significant change in pose for both of the persons 20. By setting a threshold for the dissimilarity value as 0.5, all frames can be classified where the dissimilarity values are greater than 0.5 as frames having a significant pose change. Therefore, for the person 20-5, significant pose change occurs between frame numbers 50 and 80, while for the person 20-6, significant pose change occurs between frames 70 and 90. Thus, for frame numbers between 70 and 80, significant pose change occurs for both of the person 20-5 and 20-6 (i.e., the time window of significant pose changes in the change models 40-5 overlaps the time window of significant pose changes in the change model 40-6). Therefore, a causal interaction is detected in frames 70 to 80 between the persons 20-5 and 20-6.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magnetooptical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The whole or part of the example embodiments disclosed above can be described as, but not limited to, the following supplementary notes.

### Supplementary Notes

### (Supplementary Note 1)

A causal interaction detection apparatus comprising:
at least one processor; and
memory storing instructions;
wherein the at least one processor is configured to execute the instructions to:
   extract pose information for each of persons detected from a video data, the pose information indicating poses of the person in a time series;
   generate, for each of the persons, a change model that shows change in pose over time based on the pose information;
   determine, for each of one or more sets of a plurality of the persons, whether times of changes in pose of the persons in the set correlate with each other; and
   detect the persons whose times of changes in pose are determined to correlate with each other, as the persons having a causal relationship with each other,

### (Supplementary Note 2)

The causal interaction detection apparatus according to supplementary note 1,

wherein the at least one processor is further configured to:
determine whether a first time window overlaps a second time window, the first time window being a period of time in which a degree of change in pose of a first person is equal to or greater than a threshold, the second time window being a period of time in which a degree of change in pose of a second person is equal to or greater than the threshold; and
determine the times of changes in pose of the first person correlate with the times of changes in pose of the second person when the first time window is determined to overlap the second time window.

### (Supplementary Note 3)

The causal interaction detection apparatus according to supplementary note 1,

wherein the at least one processor is further configured to:
determine whether an interval between a first time window and a second time window is equal to or less than a first threshold, the first time window being a period of time in which a degree of change in pose of a first person is equal to or greater than a second threshold, the second time window being a period of time in which a degree of change in pose of a second person is equal to or greater than the second threshold; and
determine the times of changes in pose of the first person correlate with the times of changes in pose of the second person when the interval is determined to be equal to or less than the first threshold.

### (Supplementary Note 4)

The causal interaction detection apparatus according to supplementary note 1,

wherein the at least one processor is further configured to:
determine whether a distance between a first person and a second person is equal to or less than a threshold; and
determine the first person does not have a causal relationship with the second person when the distance is determined to be larger than the threshold.

### (Supplementary Note 5)

The causal interaction detection apparatus according to supplementary note 1,

wherein the at least one processor is further configured to:
determine whether a first person faces a second person; and
determine the first person does not have a causal relationship with the second person when the first person does not face the second person.

### (Supplementary Note 6)

The causal interaction detection apparatus according to any one of supplementary notes 1 to 5,

wherein the pose information represents the pose of the person at a frame of the video data by co-ordinates of multiple keypoints of the person detected from the frame.

### (Supplementary Note 7)

The causal interaction detection apparatus according to any one of supplementary notes 1 to 6,

wherein the change model of the person represents the change in pose of the person at a frame of the video data by a dissimilarity value between the pose of the person at the frame and a reference pose.

### (Supplementary Note 8)

The causal interaction detection apparatus according to supplementary note 7,

wherein the dissimilarity value for the person at a frame of the video data is computed as a distance between the pose of the person at the frame and the reference pose.

### (Supplementary Note 9)

A control method performed by a computer, comprising:
extracting pose information for each of persons detected from a video data, the pose information indicating poses of the person in a time series;
generating, for each of the persons, a change model that shows change in pose over time based on the pose information;
determining, for each of one or more sets of a plurality of the persons, whether times of changes in pose of the persons in the set correlate with each other; and
detecting the persons whose times of changes in pose are determined to correlate with each other, as the persons having a causal relationship with each other.

### (Supplementary Note 10)

The control method according to supplementary note 9, further comprising:
determining whether a first time window overlaps a second time window, the first time window being a period of time in which a degree of change in pose of a first person is equal to or greater than a threshold, the second time window being a period of time in which a degree of change in pose of a second person is equal to or greater than the threshold; and
determining the times of changes in pose of the first person correlate with the times of changes in pose of the second person when the first time window is determined to overlap the second time window.

### (Supplementary Note 11)

The control method according to supplementary note 9, further comprising:
determining whether an interval between a first time window and a second time window is equal to or less than a first threshold, the first time window being a period of time in which a degree of change in pose of a first person is equal to or greater than a second threshold, the second time window being a period of time in which a degree of change in pose of a second person is equal to or greater than the second threshold; and
determining the times of changes in pose of the first person correlate with the times of changes in pose of the second person when the interval is determined to be equal to or less than the first threshold.

### (Supplementary Note 12)

The control method according to supplementary note 9, further comprising:
determining whether a distance between a first person and a second person is equal to or less than a threshold; and
determining the first person does not have a causal relationship with the second person when the distance is determined to be larger than the threshold.

### (Supplementary Note 13)

The control method according to supplementary note 9, further comprising:
determining whether a first person faces a second person; and
determining the first person does not have a causal relationship with the second person when the first person does not face the second person.

### (Supplementary Note 14)

The control method according to any one of supplementary notes 9 to 13,

wherein the pose information represents the pose of the person at a frame of the video data by co-ordinates of multiple keypoints of the person detected from the frame.

### (Supplementary Note 15)

The control method according to any one of supplementary notes 9 to 14,

wherein the change model of the person represents the change in pose of the person at a frame of the video data by a dissimilarity value between the pose of the person at the frame and a reference pose.

### (Supplementary Note 16)

The control method according to supplementary note 15,

wherein the dissimilarity value for the person at a frame of the video data is computed as a distance between the pose of the person at the frame and the reference pose.

### (Supplementary Note 17)

A non-transitory computer-readable storage medium storing a program that cause a computer to execute:
extracting pose information for each of persons detected from a video data, the pose information indicating poses of the person in a time series;
generating, for each of the persons, a change model that shows change in pose over time based on the pose information;
determining, for each of one or more sets of a plurality of the persons, whether times of changes in pose of the persons in the set correlate with each other; and
detecting the persons whose times of changes in pose are determined to correlate with each other, as the persons having a causal relationship with each other.

### (Supplementary Note 18)

The non-transitory computer-readable storage medium according to supplementary note 17,

wherein the program further causes the computer to execute:
determining whether a first time window overlaps a second time window, the first time window being a period of time in which a degree of change in pose of a first person is equal to or greater than a threshold, the second time window being a period of time in which a degree of change in pose of a second person is equal to or greater than the threshold; and
determining the times of changes in pose of the first person correlate with the times of changes in pose of the second person when the first time window is determined to overlap the second time window.

### (Supplementary Note 19)

The non-transitory computer-readable storage medium according to supplementary note 17,

wherein the program further causes the computer to execute:
determining whether an interval between a first time window and a second time window is equal to or less than a first threshold, the first time window being a period of time in which a degree of change in pose of a first person is equal to or greater than a second threshold, the second time window being a period of time in which a degree of change in pose of a second person is equal to or greater than the second threshold; and
determining the times of changes in pose of the first person correlate with the times of changes in pose of the second person when the interval is determined to be equal to or less than the first threshold.

### (Supplementary Note 20)

The non-transitory computer-readable storage medium according to supplementary note 17,

wherein the program further causes the computer to execute:
determining whether a distance between a first person and a second person is equal to or less than a threshold; and
determining the first person does not have a causal relationship with the second person when the distance is determined to be larger than the threshold.

### (Supplementary Note 21)

The non-transitory computer-readable storage medium according to supplementary note 17,

wherein the program further causes the computer to execute:
determining whether a first person faces a second person; and
determining the first person does not have a causal relationship with the second person when the first person does not face the second person.

### (Supplementary Note 22)

The non-transitory computer-readable storage medium according to any one of supplementary notes 17 to 21,

wherein the pose information represents the pose of the person at a frame of the video data by co-ordinates of multiple keypoints of the person detected from the frame.

### (Supplementary Note 23)

The non-transitory computer-readable storage medium according to any one of supplementary notes 17 to 22,

wherein the change model of the person represents the change in pose of the person at a frame of the video data by a dissimilarity value between the pose of the person at the frame and a reference pose.

### (Supplementary Note 24)

The non-transitory computer-readable storage medium according to supplementary note 23,

wherein the dissimilarity value for the person at a frame of the video data is computed as a distance between the pose of the person at the frame and the reference pose.

### REFERENCE SIGNS LIST

20 person
30 video
40 change model
1000 computer
1020 bus
1040 processor
1060 memory
1080 storage device
1100 input/output interface
1120 network interface
2000 causal relationship detection apparatus
2020 pose extraction unit
2040 model generation unit
2060 correlation detection unit

What is claimed is:

1. A causal interaction detection apparatus comprising:
at least one processor; and
memory storing instructions;
wherein the at least one processor is configured to execute the instructions to:
extract pose information for each of persons detected from a video data, the pose information indicating poses of the person in a time series;
generate, for each of the persons, a change model that shows change in pose over time based on the pose information;
determine, for each of one or more sets of a plurality of the persons, whether times of changes in pose of the persons in the set correlate with each other; and
detect the persons whose times of changes in pose are determined to correlate with each other, as the persons having a causal relationship with each other.

2. The causal interaction detection apparatus according to claim 1,
wherein the at least one processor is further configured to:
determine whether a first time window overlaps a second time window, the first time window being a period of time in which a degree of change in pose of a first person is equal to or greater than a threshold, the second time window being a period of time in which a degree of change in pose of a second person is equal to or greater than the threshold; and
determine the times of changes in pose of the first person correlate with the times of changes in pose of the second person when the first time window is determined to overlap the second time window.

3. The causal interaction detection apparatus according to claim 1,
wherein the at least one processor is further configured to:
determine whether an interval between a first time window and a second time window is equal to or less than a first threshold, the first time window being a period of time in which a degree of change in pose of a first person is equal to or greater than a second threshold, the second time window being a period of time in which a degree of change in pose of a second person is equal to or greater than the second threshold; and
determine the times of changes in pose of the first person correlate with the times of changes in pose of the second person when the interval is determined to be equal to or less than the first threshold.

4. The causal interaction detection apparatus according to claim 1,
wherein the at least one processor is further configured to:
determine whether a distance between a first person and a second person is equal to or less than a threshold; and
determine the first person does not have a causal relationship with the second person when the distance is determined to be larger than the threshold.

5. The causal interaction detection apparatus according to claim 1,
wherein the at least one processor is further configured to:
determine whether a first person faces a second person; and
determine the first person does not have a causal relationship with the second person when the first person does not face the second person.

6. The causal interaction detection apparatus according to claim 1,
wherein the pose information represents the pose of the person at a frame of the video data by co-ordinates of multiple keypoints of the person detected from the frame.

7. The causal interaction detection apparatus according to claim 1,
wherein the change model of the person represents the change in pose of the person at a frame of the video data by a dissimilarity value between the pose of the person at the frame and a reference pose.

8. The causal interaction detection apparatus according to claim 7,
wherein the dissimilarity value for the person at a frame of the video data is computed as a distance between the pose of the person at the frame and the reference pose.

9. A control method performed by a computer, comprising:
extracting pose information for each of persons detected from a video data, the pose information indicating poses of the person in a time series;
generating, for each of the persons, a change model that shows change in pose over time based on the pose information;
determining, for each of one or more sets of a plurality of the persons, whether times of changes in pose of the persons in the set correlate with each other; and
detecting the persons whose times of changes in pose are determined to correlate with each other, as the persons having a causal relationship with each other.

10. The control method according to claim 9, further comprising:
determining whether a first time window overlaps a second time window, the first time window being a period of time in which a degree of change in pose of a first person is equal to or greater than a threshold, the second time window being a period of time in which a degree of change in pose of a second person is equal to or greater than the threshold; and
determining the times of changes in pose of the first person correlate with the times of changes in pose of the second person when the first time window is determined to overlap the second time window.

11. The control method according to claim 9, further comprising:
determining whether an interval between a first time window and a second time window is equal to or less than a first threshold, the first time window being a period of time in which a degree of change in pose of a first person is equal to or greater than a second threshold, the second time window being a period of time in which a degree of change in pose of a second person is equal to or greater than the second threshold; and
determining the times of changes in pose of the first person correlate with the times of changes in pose of the second person when the interval is determined to be equal to or less than the first threshold.

12. The control method according to claim 9, further comprising:
determining whether a distance between a first person and a second person is equal to or less than a threshold; and
determining the first person does not have a causal relationship with the second person when the distance is determined to be larger than the threshold.

13. The control method according to claim 9, further comprising:
determining whether a first person faces a second person; and
determining the first person does not have a causal relationship with the second person when the first person does not face the second person.

14. The control method according to claim 9,
wherein the pose information represents the pose of the person at a frame of the video data by co-ordinates of multiple keypoints of the person detected from the frame.

15. The control method according to claim 9,
wherein the change model of the person represents the change in pose of the person at a frame of the video data by a dissimilarity value between the pose of the person at the frame and a reference pose.

16. The control method according to claim 15,
wherein the dissimilarity value for the person at a frame of the video data is computed as a distance between the pose of the person at the frame and the reference pose.

17. A non-transitory computer-readable storage medium storing a program that cause a computer to execute:
extracting pose information for each of persons detected from a video data, the pose information indicating poses of the person in a time series;
generating, for each of the persons, a change model that shows change in pose over time based on the pose information;
determining, for each of one or more sets of a plurality of the persons, whether times of changes in pose of the persons in the set correlate with each other; and
detecting the persons whose times of changes in pose are determined to correlate with each other, as the persons having a causal relationship with each other.

18. The non-transitory computer-readable storage medium according to claim 17,
wherein the program further causes the computer to execute:
determining whether a first time window overlaps a second time window, the first time window being a period of time in which a degree of change in pose of a first person is equal to or greater than a threshold, the second time window being a period of time in which a degree of change in pose of a second person is equal to or greater than the threshold; and
determining the times of changes in pose of the first person correlate with the times of changes in pose of the second person when the first time window is determined to overlap the second time window.

19. The non-transitory computer-readable storage medium according to claim 17,
wherein the program further causes the computer to execute:
determining whether an interval between a first time window and a second time window is equal to or less than a first threshold, the first time window being a period of time in which a degree of change in pose of a first person is equal to or greater than a second threshold, the second time window being a period of time in which a degree of change in pose of a second person is equal to or greater than the second threshold; and
determining the times of changes in pose of the first person correlate with the times of changes in pose of the second person when the interval is determined to be equal to or less than the first threshold.

20. The non-transitory computer-readable storage medium according to claim 17,
wherein the program further causes the computer to execute:
determining whether a distance between a first person and a second person is equal to or less than a threshold; and
determining the first person does not have a causal relationship with the second person when the distance is determined to be larger than the threshold.

21-24. (canceled)
